(19) United States
(12) Patent Application Publication
(10) Pub. No.: US 2005/0182233 A1
(43) Pub. Date: Aug. 18, 2005

(54) Compression-induced crystallization of crystallizable polymers

(76) Inventors: Stephen Weinhold, Kingsport, TN (US); Michael Eugene Donelson, Gray, TN (US); Marcus David Shelby, Kingsport, TN (US)

Correspondence Address: Eastman Chemical Company, P.O. Box 511, Kingsport, TN, 37662-5075, US

(21) Appl. No.: 11/029,296

(22) Filed: Jan. 5, 2005

Related U.S. Application Data
(60) Provisional application No. 60/540,218, filed on Jan. 29, 2004.

(51) Int. Cl. C08G 63/02

(52) U.S. Cl. 528/272

(57) ABSTRACT

A crystallization process comprising passing a mass of amorphous crystallizable polymer having a first thickness (ft) through the nip gap of counter-rotating rolls having a nip gap (ng) at an ft:ng ratio of at least 1.2 to crystallize the polymer to a degree of crystallinity of at least 15% and thereby produce a semi-crystalline polymer, and particulating the semi-crystalline polymer. Strain crystallizing a sheet or fiber by using a drafting step to elongate the sheet or fiber is no longer needed. A high degree of crystallinity is imparted almost instantaneously, even in slow to crystallize copolyesters. The process allows one to extrude a thinner crystallizable sheet, substantially retains the dimensional width of the sheet as it is passed through the compression rolls, and produces substantially optically clear sheet and pellets. Suitable polymers include polyethylene terephthalate or naphthalate homopolymers or copolymers.

### CROSS REFERENCE TO RELATED APPLICATIONS

This application claims the benefit of U.S. Provisional Application No. 60/540,218, filed Jan. 29, 2004, the entirety of which is hereby incorporated by reference.

### 1. FIELD OF THE INVENTION

This invention pertains to methods for crystallizing amorphous crystallizable polymers, and in particular, to almost instantaneously compression crystallization shaped amorphous but crystallizable polymers such as polyester polymers.

### 2. BACKGROUND OF THE INVENTION

Crystallizable polymers can be divided into two classes based upon their speed of crystallization. Fast to crystallize polymers develop substantial crystallinity during typical processes in which the polymer melt is processed to form pellets. The semicrystalline pellets thus formed need be subjected to no further crystallization process to be suitable for use in subsequent forming or processing operations such as extrusion or injection molding. Polyethylene and polypropylene are examples of fast to crystallize polymers.

Slow to crystallize polymers develop little or no crystallinity during the process in which the polymer melt is processed to form pellets. These amorphous pellets must be subjected to a subsequent crystallization process to develop a substantial degree of crystallinity. The development of crystallinity is preferred because when crystalline, the pellets can be dried at higher temperatures without sticking together to remove absorbed water prior to feeding the pellets to an extruder, such as an injection molding machine. Drying the pellets prior to extrusion is required because polyesters are hydrolytically unstable and have to be thoroughly dried before extruding or molding to prevent IV degradation. Being able to dry at higher temperatures means better drying efficiency. Amorphous polyesters can only be dried at temperatures below the Tg of the polymer (typically 70 to 80° C.) because of the sticking/clumping problem. Crystalline versions of the same polyesters, however, can be dried at much higher temperatures (usually around 150 to 175° C.) and thus can be thoroughly dried in a much shorter time.

Crystallinity is also desired because the pellets will flow better down the barrel of an extruder or injection molding machine. Furthermore, having crystalline pellets is advantageous from a manufacturing standpoint in that, optionally, they can be further polymerized (without melting) via a process known as “solid stating”.

Crystallization of the amorphous pellets produced from a melt phase reactor is most commonly done by heating amorphous pellets to a temperature between the glass transition temperature (Tg) and the melting temperature (Tm) and maintaining that temperature under constant stirring/agitation to avoid sticking for whatever time is required to develop the desired degree of crystallinity. The required time may be as little as a few minutes for a moderately slow to crystallize polymer such as poly(ethylene terephthalate) (PET) to as much as many hours for a very slow to crystallize polymer such as a highly modified copolyester. This process is known as a thermal crystallization process because spherulitic crystallinity is imparted to the pellets thermally, often in a fluid such as a hot stream of nitrogen gas, and is usually performed in a “crystallizer”. The crystallizer is nothing more that a heated vessel with a series of paddles or agitator blades to keep the pellets stirred. Alternately, a crystallizer can consist of a hot, fluidized bed for keeping the pellets apart. If the polyester or co-polyester crystallizes very slowly, then the latter type cannot be applied because the softened sticky pellets will eventually clump together and disrupt the fluidized bed before crystallization can occur.

The amorphous pellets are sticky and adherent during the period when their temperature is above the Tg but prior to their crystallization, and unless effective measures are taken to prevent it the sticky pellets will agglomerate to form an adherent mass. Measures to prevent pellet agglomeration always include some type of agitation or forced motion and often incorporate a scheme by which most of the pellets in the crystallization vessel at any moment are already crystallized so as to minimize contact between two or more amorphous pellets, which can result in agglomeration. Thus, the average residence time of pellets in the crystallization vessel is much longer than the time required for a single pellet to crystallize. For instance, in typical commercial continuous crystallization processes for PET the average pellet residence time in the crystallization unit or units is on the order of one hour. The long residence time, the need for continuous agitation, and the need to heat and maintain the pellets at high temperature makes pellet crystallization a costly and energy intensive process, even for resins such as PET which are only moderately slow to crystallize.

The difficulty and cost of crystallization are magnified for resins which are more slow to crystallize due to the need for longer residence time, larger crystallization units to maintain the required output rate, and more aggressive agitation. For very slow to crystallize resins, such as certain copolyesters, the extreme difficulty of preventing pellet agglomeration and the extremely long residence time required make crystallization by conventional means and solid stating a prohibitively costly and difficult to control process. Thus, most hard-to-crystallize polyesters are neither crystallized nor solid-stated.

Accordingly, it would desirable to provide a technique which crystallizes amorphous polyester pellets quickly, does not require agitation (which often results in fines and chipping), and is able to crystallize a wide range of copolyesters which otherwise could not be crystallized in a standard fluidized bed crystallizer or which requires hours to crystallize.

Polymer pellets which have been crystallized by holding at high temperature as described above (“thermally crystallized pellets”) are almost always opaque. This is caused by the spherulitic crystalline morphology characteristic of thermally crystallized pellets. The spherulites are typically of a size which effectively scatters visible light, and this causes the pellets to appear opaque. However, the articles or product made from the pellets of slow to crystallize polymer—for example, film, sheet, containers, and injection molded parts—are typically transparent, and the color of the transparent articles or product is an important characteristic. While the color of the opaque thermally crystallized pellets can be measured, these results are often not representative of the appearance of the resin after it has been processed into a transparent article or product.

Also, there may be upsets from time to time in the manufacturing process of the polymer which causes the resin to become contaminated with small pieces of degraded polymer or other visible particulate contaminant (“black specks”). The resin is inspected for black specks prior to pellet crystallization, while the pellets are amorphous and transparent, but the inspection process is not perfect and occasionally pellets contaminated with black specks may be further processed into thermally crystallized pellets. Because the crystallized pellets are opaque, the black specks are hidden and no longer visible, and the consumer of the pellets is unaware of the contamination until the resin has been processed into a transparent product of article, at which point the black specks are again visible. Since products or articles containing black specks are unacceptable, substantial production time and resources may be wasted manufacturing unacceptable product until the black speck problem is detected, and the black speck problem may be further propagated by the inadvertent shipment of contaminated products or articles.

Tensile strain induced crystallization, to be contrasted with thermally induced crystallization, has been proposed in U.S. Pat. No. 6,159,406. In this technique, a polyester polymer melt from the melt phase is extruded through a strand or sheet die, and the strands or sheet are subjected to tensile stretching on a drafting station to impart orientation to the amorphous polymer, and thereby impart a strain-induced crystallinity to the strands/sheet, following which the strand/sheet is pelletized. To help impart strain-induced crystallization, it was also proposed that a sheet can be fibrillated by creating a corrugated or castellated surface on the sheet, followed by a drafting step to stretch and elongate the sheet and split the sheet into thin strands. As an alternative method, a variation on fibrillation was proposed to extruding a flat film through the melt reactor die, onto a casting or chill roll, passing the film through a set of embossing rolls to impart the castellated surface, followed by drafting to orient, crystallize and split the fibers using the similar stretch ratios to the strand method. It was also hypothesized that the embossing/castellation method can increase the amount of crystallinity by squeezing in crystallinity prior to drafting. However, in this latter process, it is clear that only a small amount of crystallinity should be “squeezed” into the sheet because too much crystallinity imparted at the castellation step will prevent the sheet from being drawn and stretched at the draft station to the degree necessary to strain crystallize. Thus, the sheet introduced into the drafting station must remain sufficiently amorphous to allow it to be elongated and strain-crystallized.

By these methods, the polyester polymer is crystallized at a rate much faster than could occur using a traditional thermal crystallizer. Moreover, the strain crystallized pellets were optically clear. While each of the techniques disclosed in U.S. Pat. No. 6,159,406 represented a large advance in the art toward economical fast rate crystallization techniques that could crystallize a wide range of co-polyesters and produced optically clear pellets, each technique relied upon the use of elongating or stretching the polyester polymer, whether in the form of a sheet or strand, to orient the polymer chains and thereby impart crystallinity. Polymer chain orientation through drawing and elongation changes the dimension of the sheet and/or strand to a large extent. Drawing down strands at a drawdown ratio (draw rate of second godet to first godet) of 3 to 7 was given as an illustration. Such large ratios significantly reduce the diameter of the strand, thereby requiring a starting strand die diameter to be large to compensate for the final strand diameter. This problem persists in a process of castellating a sheet through embossing rolls followed by splitting and elongating the sheet, rendering the process more difficult to design since a very thick sheet or large diameter strand must be made initially to compensate for the large thickness reduction during the drawing step. Moreover, the time required to equilibrate the sheet or strand temperature to that desired during the crystallization step increases with the square of the sheet or strand thickness. Thus, it is more desirable to start with a sheet which more closely approximates the semi-crystallized sheet thickness or the pellet thickness. It would also be desirable to crystallize amorphous polymer without the need for a drafting station to impart strain-crystallization, but which also avoids the long residence time encountered in a conventional thermal crystallization methods.

Accordingly, it would be desirable to relatively instantly crystallize a wide array of amorphous polyester polymers and produce optically clear pellets as in a strain crystallization method, but without the necessity for a drafting station to elongate the sheet or fibers 3-7×.

### 3. SUMMARY OF THE INVENTION

The present invention is a novel crystallization method which causes crystallization to occur almost instantaneously, even for polymers which are slow or very slow to crystallize by typical thermal crystallization processes. This reduces the cost of crystallization and eliminates the problem of pellet agglomeration during the thermal crystallization process. Another aspect of the invention is the optical characteristics of the crystallized resin; that is, resin crystallized by the method of this invention is substantially transparent, which enables more representative color measurements and the inspection by eye alone of the resin for black speck contamination by the user of the resin. Moreover, the present invention does not strain-crystallize amorphous polymer through a tensile stretching or elongating step, thereby dispensing with the need for a drafting station and allowing more flexibility in the thickness of the sheet extruded from the die.

There is now provided a crystallization process comprising passing a mass of amorphous crystallizable polymer having a first thickness (ft):

a) through the nip gap of counter-rotating rolls having a nip gap (ng) at an ft:ng ratio of at least 1.2 to crystallize the polymer to a degree of crystallinity of at least 15% and thereby produce a semi-crystalline polymer, and

b) particulating the semi-crystalline polymer.

In the process of the invention, strain crystallizing a sheet or fiber by using a drafting step to elongate the sheet or fiber is not only no longer needed, but is also no longer used. The invention takes advantage of the recognition that now a high degree of crystallinity, even a final desired degree of crystallinity, can be imparted by compression crystallizing the polymer. Thus, the present invention dispenses with the need for a drafting/elongation equipment, allows one to extrude a thinner crystallizable sheet, does not rely upon the use of embossing or castellating rolls, and surprisingly substantially retains the dimensional width of the sheet as it is passed through the compression rolls.

In another embodiment, there is provided a process for crystallizing a mass of amorphous but crystallizable polymer having a first thickness (ft) by:

a) passing the amorphous mass through counter-rotating rolls resulting in semi-crystallized mass having a second thickness (st), wherein the ratio of ft:st is at least 1.1, and

b) particulating the mass of polymer without substantially drawing the semi-crystallized mass after passing the amorphous mass through the rolls.

In yet a further embodiment, there is provided a continuous process for crystallizing a sheet of amorphous but crystallizable polymer comprising compressing the sheet to crystallize the polymer to a degree of crystallinity of at least 30%.

The preferred polymer is a polyethylene terephthalate homopolymer or copolymer.

### 4. DETAILED DESCRIPTION OF THE INVENTION

The polymer mass can by any amorphous but crystallizable polymer. Examples of such polymers include crystallizable partially aromatic polyamides, and crystallizable polymers having terephthalate and/or naphthalate repeating units. The present invention provides quick and convenient compression induced crystallization to polyesters having zero, low, and high copolymer modification, such as above about 5 and even above 10 mole %. In certain embodiments polyester copolymers having between about 5 and 20 mole % copolymer modification are preferred. Polyester copolymers having slow thermal crystallization rates can be rapidly crystallized by the method of the present invention. The crystallization rate is measured using crystallization half times from the glass at the temperature of maximum crystallization rate (which depends on the polymer). Highly modified, previously slowly crystallizing polyesters, can, in accordance with the present invention be readily crystallized.

Preferred polymers are polyesters, more preferably those having aromatic rings in the backbone. Suitable polyesters comprise a dicarboxylic acid component and a glycol component. The polycarboxylic acid component comprises terephthalic, isophthalic, naphthalenedicarboxylic, 1,4-cyclohexanedicarboxylic acid, phenylenedioxydiacetic acid, as well as the lower alkyl ester or acid chlorides thereof, and mixtures thereof and the like. The various isomers of naphthalenedicarboxylic acid or mixtures of isomers may be used but the 1,4-, 1,5-, 2,6-, and 2,7-isomers are preferred. The 1,4-cyclohexanedicarboxylic acid may be in the form of cis, trans, or cis/trans mixtures. The various isomers of phenylenedioxydiacetic acid or mixtures of isomers may be used but the 1,2-, 1,3-, 1,4-isomers are preferred.

The polycarboxylic acid component of the polyester may optionally be modified with up to about 40 mole percent of one or more polycarboxylic acids, based on 100 mole % of all poly-carboxylic acid residues in the polymer. Such modifier polycarboxylic acids include the acids mentioned above in amounts of 40% or less, such as terephthalic acid as the base with 40% or less of IPA or NDA, or naphthalenedicarboxylic acids as the base with 40 or less of IPA or TPA, or other acids having from 6 to about 40 carbon atoms, and more preferably dicarboxylic acids selected from aromatic dicarboxylic acids preferably having 8 to 14 carbon atoms, aliphatic dicarboxylic acids preferably having 4 to 12 carbon atoms, or cycloaliphatic dicarboxylic acids preferably having 7 to 12 carbon atoms. Examples of suitable dicarboxylic acids include phthalic acid, isophthalic acid, naphthalene-2,6-dicarboxylic acid, cyclohexanedicarboxylic acid, cyclohexanediacetic acid, diphenyl-4,4′-dicarboxylic acid, 1,3-phenylenedioxydiacetic acid, 1, 2-phenylenedioxydiacetic acid, 1,4-phenylenedioxydiacetic acid, succinic acid, glutaric acid, adipic acid, azelaic acid, sebacic acid, mixtures thereof and the like.

Typical glycols useful as the poly-ol component in the polyester include aliphatic glycols containing from two to about ten carbon atoms, cycloaliphatic diols preferably having 6 to 20 carbon atoms, aromatic diols containing from 6 to 15 carbon atoms or aliphatic diols preferably having 3 to 20 carbon atoms, and mixtures thereof. Examples of such diols include: diethylene glycol, triethylene glycol, 1,4-cyclohexanedimethanol (when using 1,4-cyclohexanedimethanol, it may be the cis, trans or cis/trans mixtures), propane-1,3-diol, butane-1,4-diol, pentane-1,5-diol, hexane-1,6-diol, 3-methylpentanediol-(2,4), 2-methylpentanediol-(1,4), 2,2,4-trimethylpentane-diol-(1,3), 2-ethylhexanediol-(1,3), 2,2-diethylpropane-diol-(1,3), hexanediol-(1,3), 1,4-di-(2-hydroxyethoxy)-benzene, 2,2-bis-(4-hydroxycyclohexyl)-propane, 2, 4-dihydroxy-1,1,3,3-tetramethyl-cyclobutane, 2,2-bis-(3-hydroxyethoxyphenyl)-propane, poly(ethylene glycol), poly(tetramethylene glycol,)1,3-bis(2-hydroxyethoxy)benzene, 1,4-bis(2-hydroxyethoxy)benzene, 2,2-bis-(4-hydroxypropoxyphenyl)-propane, resorcinol, hydroquinone and the like. Preferred modifier polyols include diethylene glycol, 1,4-cyclohexane diol and mixtures thereof.

Preferred glycols include ethylene glycol, 1,4-butanediol, 1,6-hexanediol, 1,4-cyclohexanedimethanol (CHDM), diethylene glycol, neopentyl glycol, mixtures thereof, and the like, and more preferred is ethylene glycol and 1,4-cyclohexanedimethanol and mixtures thereof.

In one embodiment, a polyester containing from 0.0 mole % to about 30 mole % of modifier glycol residues other than ethylene glycol residues based on 100 mole % of poly-ol residues is provided. There is also provided polyethylene terephthalate copolymers containing from 0.0 mole % to 30 mole % of modifier dicarboxylic acids other than terephthalic acid residues or residues of the lower alkyl esters of terephthalic acid, based on 100 mole % of all polycarboxylic acid residues.

Difunctional components such as hydroxybenzoic acid may also be used. Also small amounts of multifunctional polyols such as trimethylolpropane, pentaerythritol, glycerol and the like may be used if desired.

The resin may also contain small amounts of trifunctional or tetrafunctional comonomers to provide controlled branching in the polymers. Such comonomers include trimellitic anhydride, trimethylolpropane, pyromellitic dianhydride, pentaerythritol, trimellitic acid, trimellitic acid, pyromellitic acid and other polyester forming polyacids or polyols generally known in the art.

Also, although not required, additives normally used in polyesters may be used if desired. Such additives include, but are not limited to colorants, pigments, carbon black, glass fibers, fillers, impact modifiers, antioxidants, pinning aids, stabilizers, flame retardants, reheat aids, acetaldehyde reducing compounds, barrier enhancing compounds, oxygen scavenging compounds, UV absorbing compounds and the like.

Prior to the polycondensation of the melt-phase process, a mixture of polyester monomer (diglycol esters of dicarboxylic acids) and oligomers are produced by conventional, well-known processes. One such process is the esterification of one or more dicarboxylic acids with one or more glycols; in another process, one or more dialkyl esters of dicarboxylic acids undergo transesterification with one or more glycols in the presence of a catalyst such as a salt of manganese, zinc, cobalt, titanium, calcium, magnesium or lithium. In either case, the monomer and oligomer mixture is typically produced continuously in a series of one or more reactors operating at elevated temperature and pressures at one atmosphere or greater. Alternately, the monomer and oligomer mixture could be produced in one or more batch reactors. Suitable conditions for esterification and transesterification include temperatures between about 200° C. to about 250° C. and pressures of about 0 to about 80 psig. It should be understood that generally the lower the reaction temperature, the longer the reaction will have to be conducted.

Next, the mixture of polyester monomer and oligomers undergoes melt-phase polycondensation to produce a low molecular weight precursor polymer. The precursor is produced in a series of one or more reactors operating at elevated temperatures. To facilitate removal of excess glycols, water, alcohols, aldehydes, and other reaction products, the polycondensation reactors are run under a vacuum or purged with an inert gas. Inert gas is any gas not causing unwanted reaction. Suitable gases include, but are not limited to partially or fully dehumidified air, CO₂, argon, helium and nitrogen. Catalysts for the polycondensation reaction include salts of antimony, germanium, tin, lead, or gallium, preferably antimony or germanium. Reactions conditions for polycondensation include a temperature less than about 290° C., and preferably between about 240° C. and 290° C. at a pressure sufficient to aid in removing undesirable reaction products such as ethylene glycol. Precursor IhV is generally below about 0.7 to maintain good color. The target IhV is generally selected to balance good color and minimize the amount of solid stating required. Inherent viscosity (IhV) was measured at 25° C. using 0.50 grams of polymer per 100 ml of a solvent consisting of 60% by weight phenol and 40% by weight tetrachloroethane. The low molecular weight precursor polymer is typically produced continuously in a series of one or more reactors operating at elevated temperature and pressures less than one atmosphere. Alternately low molecular weight precursor polymer could be produced in one or more batch reactors.

Polymers having high copolymer modification may also be made by blending different polymers or polymer concentrates together. Blend components include, but are not limited to virgin polyester, polyester scrap, recycled polyester and copolyesters and polyester concentrates. The blend components may be added to the virgin polymer in a number of ways including admixing with virgin pelletized polyester, admixed with molten polyester from the polymerization reactor and the like. The blends are then extruded and crystallized as described above. Aside from blends, copolyesters may be formed by adding comonomers to the polymerization reactor and also by adding to the melt phase any one of polyester scrap, post consumer recycled polyester and the like and mixtures thereof.

In one embodiment, the polyester polymers are virgin polyethylene terephthalate homopolymers or copolymers containing 10 mole % or less of a polyol residue other than ethylene glycol residues.

In one embodiment of the invention, a molten stream of polymer is forced through a die to form an amorphous but crystallizable shaped article, the shaped article is continuously passed through counter-rotating rolls to form a semi-crystallized sheet having a degree of crystallinity of at least 15%, and the semi-crystallized sheet is particulated to form particles.

In a conventional process, the polymer made in the melt phase is typically pelletized, cooled, thermally crystallized, and then solid stated. In the process of the invention, the polymer of the melt phase may also be pelletized, cooled, but is then subsequently re-melted, extruded or otherwise forced through a die to make a shaped article, and then continuously passed through a means for compressing the shaped article sufficiently to impart a desired degree of crystallization to the polymer. Alternatively and preferably, instead of re-melting cooled pellets in an extruder, the melt phase product can be introduced into a melt pumping device such as a gear pump or other metering device to force the molten polymer through a die to form the shaped article. This avoids the step of pelletization, cooling, storage of the pellets, and avoids the consumption of energy to re-melt pellets.

If desired, one may feed post consumer recycle (PCR), scrap, and/or additives to an extruder to provide a second molten stream subsequently fed to a mixing device to converge and mix a virgin feed with the second molten stream, thereby producing a mixed third stream forced through a die. In any event, a molten stream of polymer is forced through a die suitable to form a shaped article.

The shaped article can be of any shape, but preferably has an aspect ratio defined as the ratio of width to thickness of a cross-section cut of at least 2, preferably at least 5, more preferably at least 10. The shaped article is desirably planar, and can include sheets, tapes (also known as ribbons), and films.

The shaped article also has a first thickness (ft). While the thickness is not particularly limited, for ease of fabrication, it is preferred to set the dimension of the first thickness to about the desired particle thickness, taking into account the desired nip gap and degree of polymer rebound as the shaped article exits the counter-rotating rolls. The particle thickness, while also not particularly limited, is desirably the conventional thickness of delivered particles for which industry is accustomed to. Moreover, the particle thickness will be limited by the capabilities of slitters and/or pelletizers to cut crystallized shaped articles, as well as the desired production rate. A first thickness of 1 mm to 8 mm, or 2 mm to 5 mm is suitable and would be most commonly used.

The shaped article is amorphous prior to being compression crystallized. By amorphous is meant that the degree of crystallization in the shaped article is less than desired and which is sufficiently low to allow the shaped article to be compressed through rolls to impart at least an additional 5% degree of crystallization. In most cases, the degree of crystallization of an amorphous shaped article is less than 8%, and more commonly 5% or less.

After forming the amorphous but crystallizable shaped article, it is fed, preferably continuously fed, through counter-rotating rolls having a nip gap (ng) at a ft:ng ratio of at least 1.2 to crystallize the polymer to a degree of crystallinity of at least 15%, as measured by DSC. The counter-rotating rolls have a gap between the two rolls which must set to provide the shaped article (for brevity hereafter called a sheet) with sufficient compressive forces to crystallize the polymer. Without being bound to a theory, it is believed that the motion of the sheet passing through the rolls in combination with the compressive forces provided by a smaller nip gap than the first thickness of the sheet will orient the polymer chains in the direction of the sheet feed, thereby crystallizing the sheet.

The ft:ng ratio is preferably at least 1.3. While no upper limit is provided, for practical considerations, an ft:ng ratio of no more than 3 is all that is needed to impart the desired crystallinity (e.g. up to about 50%). An ft:ng ratio ranging from 1.5 to 2.5 is a good range within which to operate to compression crystallize the polymer while providing adequate line speeds, less wear and tear on the roller bearings, less energy consumption, and substantially maintaining the dimension of the shaped article as it is passed through the rolls.

In another embodiment, the ratio of the ft to the second thickness (st) defined as the thickness of the semi-crystallized sheet is at least 1.05 and more preferably at least 1.15. Thus, the ng is set sufficiently narrow to provide the desired ft:st ratio. However, as noted above, an advantage of the invention is that one may start with a thinner sheet than used in a strain-crystallizable process since no draw on the sheet is needed. Accordingly, it is possible to start with a first sheet thickness ft which approximates the thickness of the second sheet thickness st, or which closely approximates the final desired pellet thickness. Therefore, in one embodiment, the ft:st ratio is preferably not higher than 2:1.

The temperature of the polymer as it enters the roll nip may range from the glass transition temperature (Tg) of the amorphous polymer to the melting temperature of semicrystalline polymer (Tm). Preferably, the temperature is at least 10° C. above the Tg, more preferably at least 20° C. above the Tg, and most preferably the temperature is at least 30° C. above the Tg. Also, the temperature is preferably at least 10° C. below the Tm, more preferably at least 20° C. below the Tm, and most preferably at least 30° C. below the Tm. If the temperature is too low, e.g. below the Tg, the polymer chains resist orientation to a great extent. If the polymer is too hot, e.g. above melting, chain orientation and crystallization is not possible. For most polymers, the shaped article temperature introduced into the compression rolls ranges from T_{g}+20° C. to T_{g}+100° C., or T_{g}+30° C. to T_{g}+90° C.

The amorphous sheet may be either heated from the glass or cooled from the melt to achieve the required temperature at which roll compression takes place. It is more desirable to cool the amorphous sheet from the melt to conserve energy costs.

The shaped polymer may be dropped onto chilled rolls, or passed through a water cabinet, or even further heated by IR lamps prior to entering the nip gap on the compression rolls if desired, so as to equilibrate the temperature throughout the shaped article as it is introduced into rolls.

The compression process may be intermittent or batchwise, in which discrete pieces of sheet are passed through the roll nip, or the process may be continuous, in which a continuous supply of amorphous polymer is created in the proper shape and at the proper temperature to be fed into the roll nip.

The temperature of the compression rolls is not limited. However, polymer slippage occurring during the feed into the roll nip can be avoided by heating the rolls. Polymer slippage is more problematic with polished surfaces. Accordingly, the rolls are desirably heated to a temperature within a range of 100° C. to 180° C. to promote take-up of the sheet fed into the roll nip.

The texture of the compression counter-rotating rolls is not particularly limited. Since the process of the invention does not use a drawing step to crystallize the amorphous shaped article, the cost of castellating or embossing rolls which apply a longitudinal corrugation to the sheet to aid splitting the sheet into strands can be avoided. It is preferred to use smooth rolls which do not impart a texture the surface of the sheet. Thus, in one embodiment, at least 80%, preferably at least 90% of the surface of the sheet is crystallized upon passing the amorphous sheet through the rolls.

The feed rate of the sheet through the counter-rotating compression rolls is not limited. The feed rate is ultimately controlled by the rate at which the cutters can particulate the sheet. Thus, the faster the particulators can cut, the more molten polymer can be extruded, thereby increasing the production rate. While the feed rate of the amorphous sheet fed through the rolls is not limited, the counter-rotating roll speed is not designed to substantially elongate the sheet by pulling the sheet through the roll at a faster rate than the rate at which the molten polymer is extruded through the die. While the counter-rotating roll speed may be set to keep the sheet in tension, thereby preventing large sags, the roll speed is not designed to be set high enough to cause orientation induced crystallization prior to entering the nip gap. If the amorphous sheet is elongated by the tension, the elongation is desirably less than 0.25× the sheet length in the absence of such tension, which is entirely insufficient to strain-crystallize the polymer.

It was surprising to find that the discharge rate of the semi-crystallized sheet from the counter-rotating rolls was significantly faster than the feed rate of the amorphous sheet to the rolls. It was expected that the sheet passing through the rolls would spread under the compressive forces to an extent that the discharge rate would not be much faster than the feed rate. However, it was surprising to find that the sheet substantially maintained its dimensional width (i.e. an change in width of less than 25% under the compressive forces between the rolls. In one embodiment, the width of the sheet is not changed by more than 20%, more preferably not changed by more than 15%, most preferably by not more than 10% of the sheet width fed into the rolls.

As a result of the sheet becoming thinner but not wider, the sheet discharge rate is correspondingly faster. Thus, the feed rate into the particulator is higher than the feed rate of the sheet into the roll. The roll speed is desirably set such that the ratio of the sheet discharge rate (v2) to the sheet feed rate into the rolls (v1) should be set to be between 80% to 120% of the ratio of ft:st. By contrast, most embossing and castellating rolls/processes have a v2/v1 ratio close to 1, so there is little or no sheet compression and thus, no significant sheet crystallization (the compressive stresses are only high on the raised pattern region of the embossing roll which is not enough to impart significant crystallinity).

While any number and types of processing steps may be used between compression crystallizing and particulating, an advantage of the invention is that strain crystallizing a sheet or fiber by using a drafting step to elongate the sheet or fiber is not only no longer needed, but preferably is also no longer used. The invention takes advantage of the recognition that now a high degree of crystallinity, even a final desired degree of crystallinity, can be imparted by compression crystallizing the polymer. Accordingly, in another embodiment, the sheet is crystallized and then particulated, such as in a pelletizer, without substantially drawing the sheet after passing the sheet through the rolls. A substantial draw is certainly a 1.5× or higher draw, but as noted above, some leeway is given to keep the sheet in tension to avoid large sags. Thus, if the semi-crystallized sheet is elongated by the tension, the elongation is desirably less than 0.25× the sheet length in the absence of such tension.

The process of the invention provides a method for compression crystallizing an amorphous sheet. The amorphous sheet is crystallized by the counter-rotating rolls to a degree of at least 15% crystallinity at the discharge of the sheet through the counter-rotating rolls. By the process of the invention, one may obtain a semi-crystallized sheet having a degree of crystallinity of at least 25%, or at least 30%, or at least 35% and even in a range of 20% to 50% or higher. The process of the invention also allows one to impart a high degree of crystallization to an amorphous sheet wherein the increase in the degree of crystallization between the amorphous sheet and the compression crystallized sheet is at least 15%, or at least 20%, or at least 25%, or at least 30%, and even at least 35%.

In another embodiment of the invention, there is provided a continuous method for crystallizing a sheet of amorphous but crystallizable polymer comprising compressing the sheet to crystallize the polymer to a degree of crystallinity of at least 30%. In this embodiment, the method is a continuous feed through a compressive force, and the action of compression imparts a degree of crystallinity to the sheet to an extent such that upon compression, the resulting sheet has a degree of crystallinity of at least 30%. It is preferred to start with an amorphous sheet having a degree of crystallinity of 10% or less.

By the method of the invention, crystallization occurs instantaneously compared to the thermal crystallization techniques known and practiced. The time necessary to obtain the desired degree of crystallinity or the increase in the degree of crystallinity of an amorphous sheet is about the residence time of the sheet between the rolls. In less than 1 second, preferably less than 0.5 seconds, more preferably less than 0.2 seconds, amorphous polymer can be transformed into semi-crystalline polymer. The process of the invention also has the advantage of short conversion times starting from extruding the melt through the die head t=0 to pelletization t=x, wherein x ranges from 5 seconds to 5 minutes. While the sheet can be subjected to longer conversion times, by the process of the invention it is possible to radically reduce the conversion time compared to conventional thermal crystallization techniques.

After compression, the sheet may optionally be annealed. Annealing in its simplest form involves restraining, or partially restraining, the sheet while simultaneously annealing it at a hotter temperature, about 150° C. to 230° C. For “non-traditional” copolyesters or polyesters with lower T_{g}'s and/or Tₘ's, the preferred annealing temperature is usually within the upper half of the difference between the T_{g} and the Tₘ of the polymer, preferably within about 10 to 40° C. of the Tₘ. Annealing times range from about 1 second to about 30 seconds or longer. Annealing can be done in-line or off-line. It should be appreciated that the hotter the temperature and the better the heat transfer the shorter the time required for annealing. Suitable annealing apparatus is known in the art and includes steam chests, hot air ovens, IR heating and the like. The equipment and conditions used in this annealing step are the same as those used for annealing film, sheet fiber and finished articles, such as containers, all of which are known in the art. While annealing normally also prevents shattering during pelletization (in the case of highly oriented pellets), sheets made by the process of the invention do not shatter when pelletized provided that the sheet temperature is within the scope of the invention. Uniform commercially desirable pellets can be made by the process of the invention without annealing, thereby saving equipment costs, energy, and increasing production.

However, annealing does allow for the formation of additional thermal crystallization around the already present compression-induced crystals, and more importantly, along the edges of the sheet where the degree of crystallization may not be as high as throughout 95%+of the sheet width. Because the amorphous sheet will slightly expand and increase the width dimension under the compressive forces of the rolls, those outer edges are not subjected to the same force as the interior of the sheet, and therefore, do not crystallize to the same degree. Since the outer edges represent less than 10%, and more commonly less than 2% of the sheet width, the pelletizer blades do not clog up as would be the case when hot amorphous sheet is cut. Nevertheless, by annealing, the degree of crystallization along the very narrow band at the edge of the sheet can be increased.

If an annealing step is used, we also surprisingly found that crystallized sheet made by the process of the invention does not require restraining during annealing to avoid substantial dimensional changes.

After the sheet has been compression crystallized, the sheet is particulated into any desired shape. The sheet may be cut by a slitter, followed by cutting with conventional pelletizers. Alternatively, the sheet may be chopped by a shredder. Any conventional cutting techniques are suitable to form particles, which include pellets, granules, chips, powder, or any other shape. The sheet fed to the pelletizer is preferably above the T_{g} of the polymer to facilitate cutting. Suitable sheet temperatures range from 110° C. to within Tₘ−10° C. into the particulator.

The resulting semi-crystallized pellets are not opaque. They have sufficient optical clarity to determine whether specks or other particulates appear in the polymer by visual inspection with the eye alone.

Optionally, the compression crystallized precursor may undergo further polycondensation in the solid state by conventional, well-known processes, such as those disclosed in U.S. Pat. No. 4,064,112. Solid state polycondensation can be conducted in the presence of an inert gas as defined above, or under vacuum conditions, and in a batch or continuous process. Temperature during the solid state polycondensation process should be about 1 to about 60° C. below the melting point of the polyester as measured by differential scanning calorimetry (DSC).

A compression crystallization line may be used to rapidly crystallize scrap polymer, including but not limited to edge trim, floor sweepings, and rejected articles, before adding the scrap back into the molding process. By installing a compression station next to the main extruder, the molten scrap/polymer blend can be compression crystallized and fed directly to the dryer(s). The compression induced crystallization of the present invention supplants the need for a thermal crystallizer. This embodiment may also be highly beneficial in the production of multilayer materials where one or more of the layers do not crystallize easily.

The semi-crystallized polyester compositions of the present invention, after drying and melt processing through, for example, an injection molding machine or extruder, can be formed into a variety of shaped articles including film, fiber, sheet, preforms, containers, profiles, tubes, trays, pipes and other packaging material.

This invention can be further illustrated by the following examples of preferred embodiments thereof, although it will be understood that these examples are included merely for purposes of illustration and are not intended to limit the scope of the invention unless otherwise specifically indicated.

### EXAMPLES

Standard PET Sheet: Unless otherwise noted, the examples were done using extrusion cast sheet of Voridian™ PET 9921. This is a glycol modified PET containing about 3.5 mole % cyclohexanedimethanol (CHDM) and about 2.7 mole % diethylene glycol (DEG) having an inherent viscosity (IhV) of about 0.76 when dissolved in PM95 solvent at a concentration of 0.5 g/dL. The standard sheet was approximately 0.136 inches thick and was cut to a length of about 9.6 inches and a width of about 3.25 inches. The standard sheet was essentially amorphous, having a crystallinity of 1.5 wt % (Table 1, Comparative Example 1) as measured by the DSC procedure described below. The standard sheet was optically transparent and free of obvious haze.

DSC Procedure: The degree of crystallinity as used throughout is characterized and measured by using Differential Scanning Calorimetry (DSC). The following method was used in the examples. A DSC was taken as a cross-sectional piece of the sample sheet; and its weight was about 9.6 mg. Samples were heated from 30° C. to 290° C. at a rate of 20° C./minute. Exothermic heat flow during the heating ramp has a numerically positive value and is indicative of crystallization. The temperature of the peak of the exotherm is designated Tch (Temperature of Crystallization upon Heating) and the area of the exothermic peak, which is equal to the amount of heat evolved during crystallization, is designated Hch (Heat of Crystallization upon Heating) and is expressed in units of Joules/gram (J/g). Endothermic heat flow during the heating ramp has a numerically negative value and is indicative of melting. The peak of the melting endotherm is designated Tm and the area of the endothermic peak, which is equal to the amount of heat absorbed during melting, is designated Hm. The theoretical heat of crystallization of 100% crystalline PET is 120 J/g and the theoretical heat of melting of 100% crystalline PET is −120 J/g. The weight percent crystallinity originally present in the sample prior to heating in the DSC is thus −(Hch+Hm)/120×100%.

The first time the sample is heated in the DSC is called the first cycle heat. Unless noted otherwise, all DSC results are for the first cycle heat. In some cases the sample was cooled from 290° C. (after holding at that temperature for 2 minutes) as quickly as the instrument would allow (several hundred degrees Celsius per minute) to 30° C. and then reheated at a rate of 20° C./min. This is called the second cycle heat.

Standard Heating and Calendering Procedure: Essentially amorphous sheet was heated using a quartz-tube infrared space heater with the heating tubes oriented horizontally with the tipover and overtemperature interlocks bypassed such that the heating tubes received full voltage continuously. The sheet was placed on a wire grill about 1.5 inches above the heating tubes for 50 to 60 seconds while occasionally flipping the sheet so that both surfaces were heated. The sheet was then removed from the heater grill and continuously flipped on a piece of corrugated cardboard for 5 to 10 seconds to allow time for a degree of temperature equilibration to occur throughout the thickness of the sheet. After this procedure the surface temperature of the sheet was measured (using a Raytek Raynger MX infrared thermometer) to be about 125° C. (standard sheet temperature). For non-standard sheet temperature, the heating time was reduced or increased to give lower or higher sheet temperature.

The heated sheet was compressed by passing it lengthwise through the nip between two smooth chrome plated polished rolls of a vertical calendar. The calender rolls were 6 inches in diameter and 12 inches long, and were turning at 8 rpm, which is equal to a circumferential roll speed of 2.5 inch/second. The calender rolls were capable of being internally heated with steam, and unless otherwise noted the rolls were heated so that their surface temperature was about 112° C. The thickness of the roll nip gap ng was adjustable by means of a hand crank, and unless otherwise noted was set to approximately 0.080 inch such that passing standard sheet at a thickness of about 0.136 inches at standard temperature through the nip produced rolled sheet about 0.085 inch thick.

### Comparative Example 1

Standard PET 9921 sheet was characterized by DSC (first and second heats) and the results are shown in Table 1. In the first heat, [Hm] (absolute value of the heat of melting) was slightly larger (by 1.8 J/g) than Hch, which corresponds to a degree of crystallinity in the standard sheet of 1.5 wt %. The results for the second heat show that the crystallinity of the sample after heating and quenching was −0.1 wt %, which is zero within experimental error. These results show that the standard sheet in its initial state may have been very slightly crystalline but was effectively amorphous. The glass transition temperature (Tg) was measured in the second heat and was found to be 80° C.

### Comparative Example 2

Standard PET 9921 sheet was heated to about 125° C., placed on corrugated cardboard, and allowed to cool naturally with no compression or deformation. DSC results (Table 1) show that this heating+cooling procedure caused a slight increase in crystallinity to 6.4 wt %.

TABLE 1
DSC Results for Comparative Examples

| | | | | | | Hm + | Crystal- |
|---|---|---|---|---|---|---|---|
| Example | Sample | Tch | Hch | Tm | Hm | Hch | linity |
| Number | Description | ° C. | J/g | ° C. | J/g | J/g | wt % |
| Comparative | Amorphous | 146.2 | 31.0 | 243.0 | −32.9 | −1.8 | 1.5% |
| Example 1 | sheet | | | | | | |
| (First | (original | | | | | | |
| Heat) | state) | | | | | | |
| Comparative | Amorphous | 177.2 | 30.6 | 241.0 | −30.5 | 0.1 | −0.1% |
| Example 1 | sheet | | | | | | |
| (Second | (reheated) | | | | | | |
| Heat) | | | | | | | |
| Comparative | Amorphous | 151.2 | 27.6 | 245.9 | −35.2 | −7.6 | 6.4% |
| Example 2 | heat | | | | | | |
| | heated | | | | | | |
| | to 125 C. | | | | | | |
| | & cooled | | | | | | |

### Examples 1-6

In this series of experiments, the effect of passing a standard PET polymer sheet on the crystallinity of the polymer was evaluate.

Standard PET 9921 sheet was heated to about 125° C. and was immediately passed through the nip of the calender. The nip gap was varied to produce rolled sheet of different thickness ranging from 0.080 to 0.109 inch. Rolled sheet having a thickness of 0.088 inch was produced on two occasions to check for reproducibility. The compression ratio achieved during rolling, defined as the original thickness of 0.136 inch divided by the thickness of the sheet after rolling, was calculated. The length of the rolled sheet increased with decreasing nip gap, but the width of the rolled sheet in all cases was essentially equal to the original width. Thus, the compression ratio calculated as the length of the sheet after rolling divided by the length of the sheet before rolling is very similar to the compression ratio calculated from the thickness reduction.

The DSC results for these samples are given in Table 2 as a function of rolled sheet thickness and compression ratio. DSC samples were taken from approximately the geometric center of the sample sheet.

The rolled sheets of Examples 1-6 all had a high degree of crystallinity, ranging from about 37 wt % to about 39 wt %. All exhibited only a very small crystallization exotherm upon heating (Hch=1.1 to 2.2 J/g), showing that the rolled sheet is substantially free of sub-Tm transitions and is thus morphologically stable. Comparing these results to that of Comparative Example 2 shows that the high degree of crystallinity in Examples 1-6 was caused by the calendering process, not by simply heating the sheet to 125° C.

Very surprisingly, the compression ratios tested (which were all above 1.1) had no significant effect on the degree of crystallinity or any of the other DSC results. This shows that a compression ratio ft:st of as little as 1.25 is sufficient to induce a high degree of crystallinity. This was very unexpected, because the large body of literature addressing strain-induced crystallization via tensile deformation of PET and other polyesters (uniaxial stretching of fibers or biaxial stretching of film or blow molded containers) shows that much larger thickness reduction or length increase ratios (typically a ratio of at least 3) are required to achieve a high degree of crystallinity, and even then the degree of crystallinity is typically about 30 wt % rather than the nearly 40% observed here.

TABLE 2
DSC Results for Examples 1-6

| | (ft) | | | | | | | |
|---|---|---|---|---|---|---|---|---|
| Ex- | thick- | Compres- | | | | | Hm + | Crystal- |
| ample | ness | sion | Tch | Hch | Tm | Hm | Hch | linity |
| Number | inch | Ratio | ° C. | J/g | ° C. | J/g | J/g | wt % |
| 1 | 0.080 | 1.70 | 191 | 1.5 | 242.7 | −47.1 | −45.7 | 38.0% |
| 2 | 0.088 | 1.55 | 180 | 1.1 | 246.7 | −47.6 | −46.6 | 38.8% |
| 3 | 0.088 | 1.55 | 180 | 1.7 | 247.0 | −46.9 | −45.2 | 37.7% |
| 4 | 0.096 | 1.42 | 182 | 1.2 | 246.0 | −46.3 | −45.1 | 37.6% |
| 5 | 0.103 | 1.32 | 180 | 2.2 | 245.3 | −46.3 | −44.1 | 36.8% |
| 6 | 0.109 | 1.25 | 177 | 1.1 | 245.1 | −46.7 | −45.6 | 38.0% |

Even though possessing a high degree of crystallinity, the rolled sheets of examples 1-6 were optically transparent and substantially free of haze over most of their area. Black 4 point Ariel print on white paper could be easily read through rolled PET sheet held 8 inches from the paper. Some haziness was visible in strips at the long edges of the rolled sheets, and the width of the hazy strips increased as the compression ratio was decreased. For the sheets made using the higher compression ratios the hazy edge strips were only slightly hazy and were confined to narrow strips just at the long edges of the sheet, while for the sheets made at the lowest compression ratio (example 6) the strips were moderately hazy and each strip was approximately 1 inch wide. It is hypothesized that the haze in the edge strips are caused by crystals sufficiently large to scatter visible light, and that these large crystals are present only along the edges of the sheets because the orientation of the PET chains is less complete at the edges of the sheet, and that the lower the compression ratio the farther this zone of incomplete orientation extends towards the centerline of the sheet. Thus, the actual width of the hazy strips is expected to be independent of the overall width of the sheet, so the amount of material in the hazy strips as a proportion of the whole is expected to become increasingly negligible as the width of the sheet increases, even for rolled sheet made with low compression ratio.

In comparison, typical PET pellets which have been thermally crystallized are white or grayish-white and completely opaque. The opacity precludes representative color measurements of the resin pellets (since the articles made from the resin are typically transparent) and obscures any “black speck” contamination which may be present within the pellets. The transparency of the compositions of this invention makes it possible to observe “black spec” contamination.

Cutting experiments were done on the rolled sheet of examples 2 and 3. In the first experiment, hot rolled sheet was taken as quickly as possible after rolling (˜10 seconds) to a large manual paper cutter (shear-type) and cut transversely into strips ˜1 cm wide. Some of these strips were then quickly cut (in the machine direction of original rolled sheet) into squares ˜1 cm on a side. The hot sheet cut easily and cleanly in both directions. However, after the sheet cooled to about room temperature it was hard and difficult to cut with the paper cutter, and commonly fractured in a brittle fashion. This shows that, if the rolled crystalline sheet is to be cut into pellets or granules, it is very preferable to do so after rolling while it remains hot. It is believed that the glass transition temperature approximately marks the temperature boundary between hot and easy to cut sheet (above the Tg) and cold and difficult to cut (below the Tg).

In another experiment, hot rolled sheet was fed as quickly as possible after rolling (˜5 seconds) into an electric office paper shredder (Fellowes Powershred model 320, 115V 5.5A motor). Because the rolled PET sheet was optically transparent, when fed into the shredder feed slot it did not interrupt the light beam of the optical switch used to trigger the shredder motor. Thus, it was necessary to back the rolled PET sheet with a single thickness of paper to trigger the optical switch. The shredder easily and with no apparent overload or hesitation cut the sheet into strips ˜0.25 inch wide.

### Examples 7-9

In this series of experiments, the effect of calender roll temperature on crystallinity was evaluated.

Standard PET 9921 sheet was heated to about 125° C. and was immediately passed through the nip of the calender. The nip gap was set to produce rolled sheet having a thickness of about 0.088 inch. The temperature of the calender rolls was varied from about 30° C. to about 115° C. DSC results are shown in Table 3.

TABLE 3

| | Calender | | | | | Hm + | Crystal- |
|---|---|---|---|---|---|---|---|
| Example | Roll Temp | Tch | Hch | Tm | Hm | Hch | linity |
| Number | ° C. | ° C. | J/g | ° C. | J/g | J/g | wt % |
| 7 | 30 | 142 | 6.4 | 242.0 | −45.9 | −39.5 | 32.9% |
| 8 | 65 | 148 | 0.4 | 247.3 | −47.2 | −46.8 | 39.0% |
| 9 | 115 | 185 | 1.9 | 245.4 | −45.6 | −43.7 | 36.4% |

The rolled sheet of example 7 produced using rolls at 30° C. had a low temperature crystallization exotherm of moderate size (Hch=6.4 J/g), indicating incomplete crystallization during rolling. It is hypothesized that the relatively cold rolls cooled the surface of the sheet and thereby prevented the sheet surfaces from crystallizing during rolling. Sheet produced at roll temperatures of 65° C. and 115° C. had much smaller low temperature crystallization exotherms and moderately higher crystallinity, and are therefore preferred. However, even the sheet of example 7 is expected to have sufficiently high crystallinity to produce processable pellets or granules.

### Examples 10-17

These examples show the effect of changing the temperature of the amorphous sheet in preparation for rolling. The amorphous sheet used was made by sawing standard PET 9921 in half longitudinally; it was about 1.6 inches wide, 9.6 inches long, and 0.138 inch thick. The heating time was varied from 20 to 67 seconds to produce hot amorphous sheet having a temperature ranging from about 80° C. to 150° C. Standard calendering conditions were used. The amorphous sheet temperature substantially influenced the thickness of the resultant rolled sheet, with higher sheet temperature generally yielding thinner sheet at constant calender nip gap. Thus, as the sheet temperature was varied it was necessary to adjust the nip gap thickness to maintain relatively constant rolled sheet thickness of 0.080 to 0.087 inch.

The DSC results for these samples are given in Table 4. DSC samples were taken from approximately the geometric center of the sample sheet. The rolled sheet thickness is also shown.

TABLE 4

| | Amor- | Rolled | | | | | | |
|---|---|---|---|---|---|---|---|---|
| | phous | Sheet | | | | | | |
| Ex- | Sheet | Thick- | | | | | Hm + | Crystal- |
| ample | Temp | ness | Tch | Hch | Tm | Hm | Hch | linity |
| Number | ° C. | (inches) | ° C. | J/g | ° C. | J/g | J/g | wt % |
| 10 | 80 | 0.080 | 116 | 8.1 | 245.0 | −50.5 | −42.5 | 35.4% |
| 11 | 90 | 0.082 | 114 | 8.0 | 244.3 | −50.9 | −42.9 | 35.7% |
| 12 | 100 | 0.083 | 124 | −0.4 | 246.8 | −49.5 | −49.9 | 41.6% |
| 13 | 110 | 0.085 | 129 | −0.7 | 241.8 | −54.4 | −55.1 | 45.9% |
| 14 | 120 | 0.082 | 147 | −1.5 | 242.3 | −60.0 | −61.5 | 51.2% |
| 15 | 130 | 0.085 | 158 | −1.7 | 247.0 | −47.4 | −49.1 | 40.9% |
| 16 | 140 | 0.086 | 162 | −1.4 | 244.8 | −50.2 | −51.6 | 43.0% |
| 17 | 150 | 0.087 | 161 | −0.2 | 242.3 | −45.7 | −45.9 | 38.2% |

A high degree of crystallinity was developed during roll compression at all amorphous sheet temperatures, but the highest crystallinity (40+wt %) was developed in the temperature range of 100° to 140° C. Also, a low temperature crystallization exotherm of significant magnitude is present in the roll compressed sheets made using amorphous sheet at 80° C. and 90° C., which indicates incomplete crystallization occurred at these sheet temperatures. Little or no low temperature crystallization is preferred, as it indicates an unstable morphology.

For examples 12 through 17, the transition labeled as Tch/Hch is actually a small melting endotherm rather than a crystallization exotherm. In all cases this transition is small (Hch less than 2 J/g) and so is not of concern.

With the exception of example 17, all of the roll compressed samples were optically transparent and substantially free of haze. Due to the high temperature to which it was heated, the amorphous sheet of example 17 had started to undergo thermal crystallization prior to being passed through the calender nip, and this thermal crystallization was the cause of the haze in the rolled sample. The rate of thermal crystallization is typically slower when cooling from the melt than when heating from the glass, so it is likely that PET 9921 cooled from the melt to 150° C. and then roll compresses would not have undergone thermal crystallization prior to rolling and would therefore be transparent and substantially free of haze.

### Examples 18-21

In these examples, the effect of inherent viscosity on crystallization were evaluated.

Plaques of three different PET resins differing only in their inherent viscosity were molded. The resins were PET modified with 3.5 mole % CHDM and about 2.7 mole % DEG. The plaques were 4 inches long, 2 inches wide, and 0.150 inch thick. The plaques were heated to the temperature shown in Table 5 and were rolled using standard calender conditions using a constant nip thickness. The thickness of the rolled plaques ranged from 0.084 to 0.091 inch. DSC samples were taken from approximately the geometric center of the sample sheet and DSC results are given in Table 5.

TABLE 5

| Example | Resin | | Sheet Temp | Tch | Hch | Tm | Hm | Hm + Hch | Crystallinity |
|---|---|---|---|---|---|---|---|---|---|
| Number | Description | IhV | ° C. | ° C. | J/g | ° C. | J/g | J/g | wt % |
| 18 | EN058 | 0.56 | 125 | 155 | 1.2 | 246.3 | −50.4 | −49.2 | 41.0% |
| 19 | 9921 | 0.76 | 125 | 140 | 0.2 | 245.0 | −47.8 | −47.6 | 39.7% |
| 20 | 9921 | 0.76 | 110 | None | 0.0 | 242.2 | −47.8 | −47.8 | 39.8% |
| 21 | 13339 | 0.95 | 110 | 144 | 0.6 | 240.3 | −46.1 | −45.5 | 37.9% |

All of the rolled plaques had a similarly high degree of crystallinity (38 to 41 wt %), and the low temperature crystallization exotherm was small in all cases (Hch=0.0 to 1.2 J/g) showing that thorough crystallization occurred during rolling for all of the resins regardless of IhV.

### Examples 22-32

These examples show the effect of CHDM modification on rolling-induced crystallization.

The resins used were polyesters of terephthalic acid and ethylene glycol modified by the amount of CHDM listed in Table 6 (total of glycols=100 mole %). The IhV of these resins is in the 0.7 to 0.8 range except for the resin of example 29, which has an IhV of about 0.6. The resin were molded into plaques 4 inches long, 2 inches wide, and 0.150 inch thick. The plaques were heated to 125° C. (except for examples 30 and 32, which were heated to 110° C.) and were rolled using standard calender conditions using a constant nip thickness. The thickness of the rolled plaques and the DSC results are given in Table 6 (DSC samples were taken from approximately the geometric center of the sample sheet). The results for example 19 are also shown in Table 6. Crystallinity is calculated assuming that the crystalline heat of melting is 120 J/g for all compositions, which is correct for PET homopolymer and lightly modified copolyesters but may be somewhat in error for resins modified with high levels of CHDM. All of the rolled plaques were optically transparent and substantially free of haze.

The last column of Table 6 shows the second cycle heat of melting. This quantity is proportional to the degree of crystallinity developed when the amorphous glassy resin is heated at a rate of 20° C./minute and therefore is directly correlated with the rate of thermal crystallization of the resin when heating from the glass (that is, large negative values of Hm mean a relatively fast rate of thermal crystallization, while values at or near zero mean a very slow or possibly infinitely slow rate of thermal crystallization). In all cases the heat of crystallization developed during the second cycle heating ramp was very similar to (but opposite in sign) to the heat of melting, showing that the resins were indeed amorphous prior to commencing the second cycle heating ramp. This confirms that the resins do not develop any substantial degree of crystallinity when cooled from the melt at a rate of several hundred °C./minute and thus it is proper to designate them as slow or very slow to crystallize resins.

TABLE 6

| | Mole | (st)Rolled | | | | | | | 2nd |
|---|---|---|---|---|---|---|---|---|---|
| Ex. | % | Thickness | Tch | Hch | Tm | Hm | Hm + Hch | Crystallinity | Heat |
| # | CHDM | inch | ° C. | J/g | ° C. | J/g | J/g | wt % | Hm J/g |
| 22 | 0 | 0.090 | none | 0.0 | 256.0 | −49.3 | −49.3 | 41.1% | −35.6 |
| 23 | 1.5 | 0.091 | 180 | 1.8 | 251.3 | −48.2 | −46.4 | 38.7% | −33.7 |
| 19 | 3.5 | 0.088 | 140 | 0.2 | 245.7 | −46.6 | −46.4 | 38.7% | −30.1 |
| 24 | 12 | 0.099 | 154 | 1.4 | 224.5 | −36.0 | −34.6 | 28.8% | none |
| 25 | 17.7 | 0.107 | 150 | 0.2 | 222.9 | −29.2 | −29.0 | 24.2% | none |
| 26 | 21.5 | 0.119 | 146 | 0.2 | 219.1 | −24.1 | −23.9 | 19.9% | none |
| 27 | 25.3 | 0.122 | none | 0.0 | 213.5 | −24.4 | −24.4 | 20.3% | none |
| 28 | 31 | 0.157 | none | 0.0 | 169.3 | −10.3 | −10.3 | 8.6% | none |
| 29 | 31 | 0.155 | none | 0.0 | 176.3 | −14.0 | −14.0 | 11.7% | none |
| 30 | 50 | 0.129 | 142 | 2.4 | 202.4 | −15.8 | −13.4 | 11.2% | none |
| 31 | 68 | 0.112 | none | 0.0 | 218.2 | −23.0 | −23.0 | 19.2% | none |
| 32 | 81 | 0.096 | none | 0.0 | 250.7 | −37.4 | −37.4 | 31.2% | −23.3 |

These examples show that roll compression induces some crystallinity in all of these resins. For the resins which undergo relatively fast thermal crystallization (examples 22, 23, 19, and 31), the degree of crystallinity is approximately 50% higher in the roll compressed plaques than the degree of crystallinity which develops when heating the amorphous glass at 20° C./min. The remaining resins shown in Table 6 undergo no thermal crystallization at all when the amorphous glass is heated at 20° C./min, but do develop substantial-to-high levels of crystallinity when the amorphous glass is roll compressed.

Even the resin of example 28, which is widely regarded as an amorphous uncrystallizable resin, develops almost 9% crystallinity when roll compressed. The following results show that this is a usefully high degree of crystallinity. An amorphous plaque of the sheet of Example 28 was heated to about 130° C., folded over upon itself so that the flat faces were in contact with one another, and compressed by hand until cool. The two faces were solidly adhered to one another and could not be separated by hand. The two faces could, with difficulty, be partially pried apart using a screw driver but when greater prying force was applied the piece fragmented. The above heating and compression procedure was repeated using a roll compressed plaque of example 28. There was little or no adhesion between the contacting faces and they could be easily separated by hand using almost no force. These results suggest that pellets or granules made from roll compressed sheet of the Example 28 polymer could be dried at much higher temperature than conventional amorphous pellets without unacceptable sticking or adhesion. Higher temperature enable much more rapid and thorough drying.

### Examples 33-45

These examples show the crystallinity developed during roll compression by polyesters, copolyesters, and a polyamide. Column 2 indicates the percentage of modifier starting material in the polyethylene terephthalate copolymer, where applicable, and where the amount is indicated as greater than 50%, the terephthalate residues and/or the ethylene glycol residues, if any, are considered to be the modifiers. The resins were molded into plaques 4 inches long, 2 inches wide, and 0.150 inch thick. The plaques were heated to a temperature 20° C. to 30° C. above their Tg (except for examples 33,42,43, and 44, which were heated to 125° C., which is about 35° C. to 40° C. above the Tg of these resins) and were rolled using standard calender conditions using a constant nip thickness equal to the nip thickness used in examples 18 to 32. The thickness of the rolled plaques and the DSC results are given in Table 7 (DSC samples were taken from approximately the geometric center of the sample sheet). Crystallinity is calculated assuming that the crystalline heat of melting is 120 J/g for all compositions, which is correct for PET homopolymer and lightly modified copolyesters but may be somewhat in error for the more highly modified resins. All of the rolled plaques were optically transparent and substantially free of haze.

The last column of Table 7 shows the second cycle heat of melting. This quantity is proportional to the degree of crystallinity developed when the amorphous glassy resin is heated at a rate of 20° C./minute and therefore is directly correlated with the rate of thermal crystallization of the resin when heating from the glass (that is, large negative values of Hm mean a relatively fast rate of thermal crystallization, while values at or near zero mean a very slow or possibly infinitely slow rate of thermal crystallization). In all cases the heat of crystallization developed during the second cycle heating ramp was very similar to (but opposite in sign) to the heat of melting, showing that the resins were indeed amorphous prior to commencing the second cycle heating ramp. This confirms that the resins do not develop any substantial degree of crystallinity when cooled from the melt at a rate of several hundred °C./minute and thus it is proper to designate them as slow or very slow to crystallize resins.

TABLE 7

| | Modifier | Amorph. | (st)Rolled | | | | | | | 2nd |
|---|---|---|---|---|---|---|---|---|---|---|
| Ex. | Mole % | Plaque | Thickness | Tch | Hch | Tm | Hm | Hm + Hch | Crystallinity | Heat |
| # | Comp. | Temp ° C. | inch | ° C. | J/g | ° C. | J/g | J/g | wt % | Hm J/g |
| 33 | 3% IPA | 125 | 0.097 | 134 | 0.1 | 249.1 | −48.7 | −48.6 | 40.5% | −31.1 |
| 34 | 8% IPA | 105 | 0.086 | 138 | 0.8 | 237.7 | −46.8 | −46.0 | 38.3% | −25.9 |
| 35 | 12% IPA | 105 | 0.093 | 131 | 3.5 | 229.5 | −49.2 | −45.7 | 38.1% | −29.2 |
| 36 | 8% N | 113 | 0.086 | 169 | 2.4 | 243.2 | −43.9 | −41.5 | 34.6% | −30.3 |
| 37 | 20% N | 118 | 0.098 | none | 0.0 | 202.3 | −27.9 | −27.9 | 23.2% | none |
| 38 | 40% N | 115 | 0.015 | none | 0.0 | none | 0.0 | 0.0 | 0.0% | none |
| 39 | 65% N | 125 | 0.015 | none | 0.0 | none | 0.0 | 0.0 | 0.0% | none |
| 40 | 100% N | 150 | 0.076 | 240 | −1.1 | 271.9 | −47.0 | −48.1 | 40.1% | −31.9 |
| 41 | 100% CHDA | 92 | 0.078 | 134 | 3.9 | 232.8 | −38.0 | −34.1 | 28.4% | −29.1 |
| | 100% CHDM | | | | | | | | | |
| 42 | 17% IPA | 125 | 0.094 | none | 0.0 | 264.1 | −41.1 | −41.1 | 34.3% | −30.3 |
| | 100% CHDM | | | | | | | | | |
| 43 | 26% IPA | 125 | 0.099 | 164 | 2.4 | 246.7 | −34.0 | −31.6 | 26.4% | −8.8 |
| | 100% CHDM | | | | | | | | | |
| 44 | 35% IPA | 125 | 0.104 | none | 0.0 | 221.1 | −26.2 | −26.2 | 21.8% | none |
| | 100% CHDM | | | | | | | | | |
| 45 | MXD-6 | 110 | 0.090 | 123 | 4.8 | 237.2 | −65.0 | −60.2 | 50.1% | −50.1 |

With the exception of examples 38 and 39, all of the resins developed a high degree of crystallinity during roll compression, even those (examples 37 and 44) which undergo no crystallization when the amorphous glass is heated at a rate of 20° C./min. The lack of rolling-induced crystallinity in examples 38 and 39 is not definitive; it is possible that some crystallization would occur if these resins were rolled at a higher temperature.

### Example 46

This example shows that roll crystallized polyester sheet can be successfully transformed into pellets suitable for subsequent melt processing operations such as extrusion or injection molding.

Amorphous PET 9921 sheet 0.150 inch thick was extrusion cast and cut into pieces 11.5 inches long and 6 inches wide. It was heated to about 130° C. and passed lengthwise through the nip of a two roll calender to make roll compressed sheet. The calender had rolls 6 inches in diameter and 12 inches long, and one roll was turning at 8 RPM and the other roll was turning at 13 RPM. The roll compressed sheet was about 0.092 inch thick and was optically transparent with only slight haze. The hot rolled sheet was immediately fed lengthwise into a model GR 450 SL band granulator manufactured by Sagitta Officina Meccanica S.p.A. (Vigevano, Italy). The granulator performed two serial operations. It first slit the sheet into strands 3 mm wide, then chopped the strands into lengths 5 mm long. The resultant rectangular pellets or granules had cleanly cut edges and were transparent with only slight haze.

DSC analysis of a pellet (X27927-118-1) showed only a single transition, a melting endotherm having Tm=246.1° C. and Hm=−48.6 J/g, which corresponds to 40.5 wt % crystallinity.

A quantity of these roll crystallized pellets were dried in a hot air desiccant pellet dryer and were then processed into extrusion cast film using a 1 inch Killion extruder having a length to diameter ratio of 24 and using a barrel temperature profile typical for normal crystalline PET pellets. No difficulties were encountered and good quality cast film was produced.

### Example 47

Example 47 demonstrates compression crystallization on a larger scale continuous process. The continuous compression crystallization line was comprised of a sheet casting section, a temperature conditioning section, a calender section, and a pelletizer section.

The sheet casting section was made up of (1) a 3.5 inch diameter plasticating single-screw extruder having a length/diameter ratio of 30; (2) a gear pump to meter the molten polymer at a constant rate; (3) a slot die for forming a narrow sheet of molten polymer, the slot being 4.0 inches wide and 0.18 inches high; and (4) a vertical stack of three stainless steel rolls, each being 32 inches in diameter and temperature controlled by means of water circulating through channels within the rolls. The material input to the sheet casting section was polymer pellets; the material output was a continuous sheet of amorphous polymer in the rubbery state.

The temperature conditioning section was made up of a continuous stainless steel mesh belt followed by a roller conveyor around which a series of quartz panel infrared heaters were positioned so as to heat both surfaces of the sheet as it traversed the conveyor. Between the mesh belt and the heater section was a set of two driven feed rolls. In operation, the sheet passed through the nip of the two rubber-coated feed rolls which clamped the sheet by means of small pneumatic cylinders. The feed rolls did not measurably deform the sheet but clamped the sheet with sufficient pressure to prevent slippage and therefore drove the sheet at a controlled speed. The material input to the temperature conditioning section was a continuous sheet of amorphous polymer having a nonuniform temperature profile through its thickness, being moderately hot on the surfaces and substantially hotter in the interior of the sheet. The material output was a continuous sheet of rubbery amorphous polymer at controlled temperature and having a more uniform temperature distribution through its thickness.

The calender section was made up of a two-roll vertical calender with chrome plated steel rolls 8 inches in diameter. The rolls were hollow and temperature-controlled oil was circulated through the rolls during operation. The two rolls were driven at equal speeds in counter-rotating directions. The material input to the calender section was a continuous sheet of rubbery amorphous polymer. The material output was a continuous sheet of substantially semicrystalline polymer at a temperature significantly greater than that of the incoming amorphous sheet.

The pelletizer section was made up of a Sagitta model GR450SL band granulator. The material input to the granulator was a continuous sheet of substantially semicrystalline polymer. The granulator divided the sheet by first slitting it along the machine direction into continuous strips, then cutting the strips in the transverse direction, such that the material output was substantially square or rectangular pellets or granules of thickness substantially equal to that of the incoming sheet, made up of substantially semicrystalline polymer.

The continuous compression crystallization line was operated using a PET resin modified with about 2.0 mole % isophthalic acid and containing about 2.7 mole % diethylene glycol. Dried pellets were delivered to the extruder feed hopper and the extruder and gear pump were operated to provide a constant melt output of about 330 pounds/hour through the slot die. The roll stack and the driven elements of the temperature conditioning section were operated at a linear speed of 18+/−0.5 feet/minute. The width of the sheet entering the oven section of the temperature conditioning section was 3.7 inches and its thickness at this point was 0.141+/−0.002 inches. At the exit of the oven section immediately before entering the nip of the calender the width of the sheet was 3.5 inches, showing that the sheet width had been reduced by about 5% during passage through the oven, presumably due to the drawing action of the calender. The sheet thickness could not be measured at this point due to accessibility constraints but is assumed to also have decreased by about 5%, resulting in the sheet thickness being about 0.134 inches immediately prior to entering the calender nip. The 5% reductions in sheet width and thickness require that the length or speed of the sheet increased by about 11% during passage through the oven. The 11% increase in sheet speed relative to its speed at the feed rolls (18 feet/minute) corresponds to a sheet speed of 20 feet/minute at the entrance to the calender. The sheet speed just prior to entering the calender nip was measured with a handheld tachometer and was found to be about 21 feet/minute, which is in acceptable agreement with the calculated speed. The temperature of the surface of the sheet was measured with an infrared pyrometer just prior to entering the calender nip and was found to be 138° C.

The calender rolls were operated at a linear speed of 26+/−0.4 feet/minute and the surface temperature of the rolls was measured to be 147+/−5° C. The nip gap between the hot rolls was measured to be 0.062+/−0.002 inch. Thus, the ft:ng ratio was about 0.134:0.062 or 2.16. The sheet was passed through the nip of the calender rolls and upon emerging was found to be 3.75 inches wide and have a surface temperature of 168° C. Its speed was measured at this point with a handheld tachometer and was found to be about 26 feet/minute, equal to the speed of the calender rolls. Thus, the sheet v2/v1 ratio was about 1.25.

The sheet was optically transparent and substantially free of haze both before and after passing through the nip of the calender rolls.

The hot sheet was passed through the Sagitta granulator and emerged as approximately square pellets about 0.125 inches on each side and 0.098+/−0.003 inches thick. The pellet thickness corresponds to the sheet thickness after passing through the calender nip. Thus, the thickness reduction ratio ft:st was about 0.134:0.098=1.37.

The pellets were analyzed by DSC. No crystallization exotherm was present, but a single melting endotherm peaking at 251° C. and having a area of 50 J/g was present. This heat of melting shows that the pellets were 42% crystalline by weight.

### Example 48

The resin of Example 24, which was PET modified with 12 mole % of CHDM, was processed on the continuous compression crystallization line using substantially the same conditions and with substantially the same results as in Example 47 with the following exceptions: the sheet temperature just prior to entering the calender nip gap was 131° C.; the bottom calender roll temperature was 157° C. and the top calender roll temperature was 134° C.; the sheet temperature just after emerging from the calender nip gap was 153° C. and the sheet width at this point was 3.65 inches; the pellet thickness was 0.102 inch; and DSC scans of the pellets revealed no crystallization exotherm and a single melting endotherm peaking at about 227° C. having an area of about 41 J/g, indication that the pellets were 34% crystalline by weight (assuming the crystalline heat of fusion is 120 J/g).

1. A crystallization process comprising passing a mass of amorphous crystallizable polymer having a first thickness (ft):
a) through the nip gap of counter-rotating rolls having a nip gap (ng) at an ft:ng ratio of at least 1.2 to crystallize the polymer to a degree of crystallinity of at least 15% and thereby produce a semi-crystalline polymer, and
b) particulating the semi-crystalline polymer.

2. The process of claim 1, wherein the polymer comprises a polyester polymer.

3. The process of claim 2 wherein the polymer contains terephthalate repeating units or naphthalate repeating units.

4. The process of claim 1, wherein the polymer comprises a polyamide polymer.

5. The process of claim 1, wherein the polymer comprises a polyethylene terephthalate homopolymer or copolymer containing from 0.0 mole % to about 30 mole % of modifier glycol residues other than ethylene glycol residues based on 100 mole % of poly-ol residues.

6. The process of claim 1, wherein the polymer comprises a polyethylene terephthalate homopolymer or copolymer containing from 0.0 mole % to 30 mole % of modifier dicarboxylic acids other than terephthalic acid residues or residues of the lower alkyl esters of terephthalic acid, based on 100 mole % of all polycarboxylic acid residues.

7. The process of claim 1, comprising forcing a molten stream of polymer through a die to form an amorphous but crystallizable shaped article, continuously passing the shaped article through counter-rotating rolls to form a semi-crystallized shaped article, and particulating the semi-crystalline shaped article to form particles.

8. The process of claim 7, wherein the amorphous shaped article has an aspect ratio of at least 5.

9. The process of claim 8, wherein the amorphous shaped article is a sheet, film, or tape.

10. The process of claim 8, wherein the amorphous shaped article has a first thickness ranging from 1 mm to 8 mm.

11. The process of claim 1, wherein the ft:ng ratio is at least 1.3.

12. The process of claim 1, wherein the ft:ng ratio is not greater than 3.

13. The process of claim 1, wherein the ft:ng ratio ranges from 1.5 to 2.5.

14. The process of claim 1, wherein the semi-crystalline polymer mass has a second thickness (st), and the ft:st ratio is at least 1.05.

15. The process of claim 14, wherein the ft:st ratio is at least 1.15.

16. The process of claim 14, wherein the ft:st ratio is not higher than 2:1.

17. The process of claim 1, wherein the temperature of the amorphous polymer as it enters the roll nip gap ranges from at least 10° C. above the Tg of the amorphous polymer to no more than 10° C. below the Tm of the amorphous polymer.

18. The process of claim 1, wherein the temperature of the amorphous polymer as it enters the roll nip gap ranges from at least 30° C. above the Tg of the amorphous polymer to no more than 30° C. below the Tm of the amorphous polymer.

19. The process of claim 1, wherein the amorphous polymer is cooled from the melt prior to passing into the rolls.

20. The process of claim 1, wherein the rolls are heated to a temperature within a range of 100° C. to 180° C.

21. The process of claim 1, wherein the rolls are smooth and do not impart a texture to the amorphous polymer mass as it passes through the rolls.

22. The process of claim 1, wherein the polymer mass is a shaped article, and at least 80% of the semi-crystalline shaped article surface is crystallized.

23. The process of claim 22, wherein at least 90% of the semi-crystalline shaped article surface is crystallized.

24. The process of claim 1, wherein the speed of the counter-rotating rolls does not substantially elongate the amorphous polymer mass.

25. The process of claim 1, wherein the discharge rate of the semi-crystallized polymer mass from the counter-rotating rolls is faster than the feed rate of the amorphous polymer mass to the rolls.

26. The process of claim 25, wherein the semi-crystalline polymer mass has a second thickness (st) upon discharge from the counter-rotating rolls, the roll speed is set such that the ratio of the semi-crystalline polymer discharge rate (v2) to the amorphous polymer feed rate into the rolls (v1) is between 80% to 120% of the ratio of ft:st.

27. The process of claim 26, wherein the polymer mass comprises a polyester polymer containing terephthalate repeating units and/or naphthalate repeating units.

28. The process of claim 1, wherein the polymer mass comprises a sheet, and the sheet substantially maintains its dimensional width after passing between the rolls.

29. The process of claim 28, wherein the width of the sheet is not changed by more than 20% of the sheet width fed into the rolls.

30. The process of claim 29, wherein the width of the sheet is not changed by more than 10% of the sheet width fed into the rolls.

31. The process of claim 1, wherein the polymer mass is crystallized without substantially drawing the sheet after passing the sheet through the rolls.

32. The process of claim 31, wherein the semi-crystalline polymer mass, after passing through the rolls, is elongated, if at all, less than 0.25× the length of the polymer mass in the absence of tension providing the elongation forces.

33. The process of claim 1, wherein the semi-crystallized sheet has a degree of crystallinity of at least 25%.

34. The process of claim 33, wherein the degree of crystallinity is at least 35%.

35. The process of claim 34, wherein the degree of crystallinity is at least 40%.

36. The process of claim 35, wherein the degree of crystallinity is at least 50%.

37. The process of claim 1, wherein the residence time between transforming the amorphous polymer into a semi-crystalline polymer having a degree of crystallinity of at least 25% is 1 second or less.

38. The process of claim 37, wherein the residence time is 0.5 seconds or less.

39. The process of claim 1, comprising extruding a melt through a die head, wherein the conversion time from extruding the melt of the amorphous polymer through the die head to particulation ranges from 5 seconds to 5 minutes.

40. The process of claim 1, further comprising annealing the semicrystalline polymer mass at a temperature ranging within the upper half of the difference between the T_{g} and the Tₘ of the polymer for 1 second to about 30 seconds.

41. The process of claim 1, further comprising annealing the semi-crystalline polymer without restraining the polymer during annealing.

42. The process of claim 1, wherein the semi-crystalline polymer mass is fed to the particulator at a temperature above the T_{g} of the polymer.

43. The process of claim 42, wherein the semi-crystalline polymer mass is fed to the particulator at a temperature ranging from 110° C. to Tₘ-10° C.

44. The process of claim 1, wherein the particles resulting from the particulator are substantially optically clear.

45. A process for crystallizing a mass of amorphous crystallizable polymer having a first thickness (ft) by:
a) passing the amorphous mass through counter-rotating rolls resulting in semi-crystallized mass having a second thickness (st), wherein the ratio of ft:st is at least 1.1, and
b) particulating the mass of polymer without substantially drawing the semi-crystallized mass after passing the amorphous mass through the rolls.

46. The process of claim 45, wherein the polymer contains terephthalate repeating units or naphthalate repeating units.

47. The process of claim 45, wherein the polymer comprises a polyethylene terephthalate homopolymer or copolymer containing from 0.0 mole % to about 30 mole % of modifier glycol residues other than ethylene glycol residues based on 100 mole % of poly-ol residues is provided.

48. The process of claim 45, wherein the polymer comprises a polyethylene terephthalate homopolymer or copolymer containing from 0.0 mole % to 30 mole % of modifier dicarboxylic acids other than terephthalic acid residues or residues of the lower alkyl esters of terephthalic acid, based on 100 mole % of all polycarboxylic acid residues.

49. The process of claim 45, comprising forcing a molten stream of polymer through a die to form an amorphous but crystallizable shaped article, continuously passing the shaped article through counter-rotating rolls to form a semi-crystallized shaped article, and particulating the semi-crystalline shaped article to form particles.

50. The process of claim 49, wherein the molten stream of polymer is forced into a die through a gear pump.

51. The process of claim 49, wherein the amorphous shaped article has an ft ranging from 1 mm to 8 mm.

52. The process of claim 49, wherein the ft:st ratio is at least 1.2:1.

53. The process of claim 52, wherein the ft:st ratio is not greater than 2:1.

54. The process of claim 49, wherein the amorphous polymer is cooled from the melt prior to passing into the rolls.

55. The process of claim 49, wherein the rolls are smooth and do not impart a texture to the amorphous polymer mass as it passes through the rolls.

56. The process of claim 49, wherein at least 80% of the semi-crystalline shaped article surface is crystallized.

57. The process of claim 45, wherein the speed of the counter-rotating rolls does not substantially elongate the amorphous polymer mass.

58. The process of claim 45, wherein the discharge rate of the semi-crystallized polymer mass from the counter-rotating rolls is faster than the feed rate of the amorphous polymer mass to the rolls.

59. The process of claim 45, wherein the ratio of the semi-crystalline polymer discharge rate (v2) to the amorphous polymer feed rate into the rolls (v1) is between 80% to 120% of the ratio of ft:st.

60. The process of claim 45, wherein the polymer mass comprises a shaped article comprising a sheet, film, or tape, and the shaped article substantially maintains its dimensional width after passing between the rolls.

61. The process of claim 45, wherein the width of the shaped article is not changed by more than 20% of the shaped article width fed into the rolls.

62. The process of claim 61, wherein the width of the shaped article is not changed by more than 10% of the shaped article width fed into the rolls.

63. The process of claim 45, wherein the semi-crystalline polymer mass, after passing through the rolls, is elongated, if at all, less than 0.25× the length of the polymer mass in the absence of tension providing the elongation forces.

64. The process of claim 45, wherein the semi-crystallized sheet has a degree of crystallinity of at least 30%.

65. The process of claim 64, wherein the degree of crystallinity is at least 40%.

66. The process of claim 45, wherein the residence time between transforming the amorphous polymer into a semi-crystalline polymer having a degree of crystallinity of at least 25% is 1 second or less.

67. The process of claim 45, comprising extruding a melt through a die head, wherein the conversion time from extruding the melt of the amorphous polymer through the die head to particulation ranges from 5 seconds to 5 minutes.

68. The process of claim 45, comprising forcing a molten stream of polymer containing repeating terephthalate units and/or repeating naphthalate units, through a die to form an amorphous but crystallizable sheet having a thickness of 1mm to 8 mm, continuously introducing the sheet through counter-rotating rolls at a feed rate (v1) and discharging the sheet from the rolls at a discharge rate (v2) to form a semi-crystallized sheet having a degree of crystallization of at least 25%, subsequently forming pellets from the sheet, wherein the ratio of v2:V1 is between 80% to 120% of the ratio of ft:st.

69. A continuous process for crystallizing a sheet of amorphous but crystallizable polymer comprising compressing the sheet to crystallize the polymer to a degree of crystallinity of at least 30%.

70. The process of claim 68, wherein the polymer comprises a polyester polymer comprising terephthalate repeating units and/or naphthalate repeating units.

71. The process of claim 70, wherein the ratio of amorphous polymer sheet thickness ft to the crystallized sheet thickness is at least 1.15:1 and not greater than 2:1.

72. The process of claim 70, wherein the residence time between transforming the amorphous polymer into a semi-crystalline polymer having a degree of crystallinity of at least 25% is 1 second or less.

73. The process of claim 70, wherein the degree of crystallinity is 40% or more.
